(19) United States
(12) Patent Application Publication
(10) Pub. No.: US 2024/0110689 A1
(43) Pub. Date: Apr. 4, 2024

(54) TOTAL REFLECTION LENS

(71) Applicant: Optronia GmbH, Innsbruck (AT)

(72) Inventor: Ulrich Hausmann, Innsbruck (AT)

(21) Appl. No.: 18/540,050

(22) Filed: Dec. 14, 2023

Related U.S. Application Data
(63) Continuation of application No. PCT/AT2022/060180, filed on May 25, 2022.

(30) Foreign Application Priority Data
Jun. 17, 2021 (AT) A 50491/2021

(51) Int. Cl. F21V 7/00; F21V 5/04; F21V 7/04; G02B 19/00

(52) U.S. Cl. CPC F21V 7/0091; F21V 5/04; F21V 7/045; G02B 19/0028; G02B 19/0061

(57) ABSTRACT

A total reflection lens includes a first end surface with a first diameter, and a second end surface parallel to the first end surface and with a second diameter. The second diameter is greater than the first diameter, and the two end surfaces are connected via a convexly curved lateral surface. A recess adjoining the first end surface and pointing in the direction of the second end surface is located between the first end surface and the second end surface. The recess has at least two boundary surface portions, pointing in the direction of the second end surface and separate from one another, for refracting light in the direction of the lateral surface.

### BACKGROUND OF THE INVENTION

The invention relates to a total reflection lens comprising a first end surface with a first diameter and a second end surface, arranged parallel to the first end surface, with a second diameter. The second diameter is greater than the first diameter, and the two end surfaces are connected via an, in particular convexly curved, lateral surface. The invention also relates to an illumination optical system comprising at least two light sources, in particular light-emitting diodes, and at least one such total reflection lens for focusing light from the at least two light sources onto an imaging area common to the two light sources. The invention furthermore relates to an array consisting of at least one such illumination optical system and at least one sensor, in particular photodiode, for the electromagnetic detection of light from the at least one illumination optical system reflected at an object. The invention lastly relates to a use of such a total reflection lens, of such an illumination optical system and/or of such an array.

Total reflection lenses of this type are generally known by the term TIR lens (total internal reflection lens) and are characterized by a substantially total internal reflection, in order to propagate light as electromagnetic radiation guided by the total reflection lens into a desired area.

Such a total reflection lens is already known from the document EP 3 480 571 A2, in which light of two wavelengths, via the total reflection lens, is utilized for animal recognition when processing an agricultural surface area, and a sensor captures the light reflected at the object to be detected. Light from a radiation source enters a body of the total reflection lens via an entry surface here and is further deflected at a lateral surface by total internal reflection, with the result that light leaves the total reflection lens through an exit surface. A surface shape of the entry surface is here designed for a high efficiency, i.e. a high level of light in the working area of the total reflection lens, wherein a conical elevation points in the direction of the radiation source and the conical elevation is arranged in a conical depression of the body of the total reflection lens.

A disadvantage of the state of the art is that a spectral analysis of the light from the radiation source is possible only to a very limited extent due to the structural design with conical elevation and conical depression and radiation sources arranged at a distance from the optical axis result in an inadequate collimation effect. A precise spectral analysis of the light is, however, indispensable for a reliable detection of objects, in particular when differentiation with respect to different wavelengths of the light is required, wherein a high collimation is of significant importance for the functionality of the total reflection lens.

### SUMMARY OF THE INVENTION

The objective technical problem of the present invention therefore consists of specifying a total reflection lens that is improved compared with the state of the art as well as an illumination optical system and array consisting of at least one illumination optical system and at least one sensor, in which the disadvantages of the state of the art are at least partially remedied, and which are characterized in particular by an improved separation of the light according to wavelength ranges and at the same time high overlapping of the wavelength ranges in an imaging area or, respectively, a high collimation and at the same time high color mixing.

Accordingly, at least one recess adjoining the first end surface and pointing in the direction of the second end surface is arranged between the first end surface and the second end surface, wherein the recess has at least two boundary surface portions pointing in the direction of the second end surface and separate from one another for refracting light in the direction of the lateral surface.

This makes it possible first of all for light from a light source to be able to enter the total reflection lens and, on entry, for the light from the light source to be split into partial beams. In the state of the art, because of the constant curvature of the entry area of the light, only a bundle of rays is available for the analysis of a spectrum of an object illuminated by the light source, as a result of which the analysis possibilities are very limited. The analysis possibilities can, however, be significantly increased according to the invention as a plurality of partial beams for each light source are obtained by the boundary surface portions, wherein the number of partial beams corresponds to the number of boundary surface portions and can be adapted to the total reflection lens depending on the requirements. The boundary surface portions act as facets, preferably curveless or planar orthogonal to an optical axis/axis of symmetry of the total reflection lens, as a result of which the spectrum of the light reflected by the object via the total reflection lens can be used particularly advantageously for a spectral analysis.

The at least two boundary surface portions are particularly preferably planar surfaces, with the result that the at least two boundary surface portions cause a segmentation of the recess and/or obtain facets of the recess. A curvature of the at least two boundary surface portions can be provided in a bidirectional spatial direction parallel to the optical axis. A curvature of the at least two boundary surface portions transverse to the optical axis, as in the case of a conical recess, is, however, detrimental with respect to collimation effects and/or a spectral separation of light and is undesired.

The at least two boundary surface portions can be connected to one another via edges and/or radii and/or be arranged adjoining one another around the optical axis, and extensions of the at least two boundary surface portions relative to one another particularly preferably comprise a discontinuous transition in the sense of an edge. A contour of the at least one recess is preferably a truncated cone, wherein the at least one recess is present in the form of a truncated pyramid (optionally with curvature of the faces of the truncated pyramid along a plane of symmetry).

Added to this is the positive property that, even in the case of light sources of different frequencies or wavelengths which are arranged with a lateral spacing around the optical axis of the total reflection lens, the partial beams split by the boundary surface portions and collimated via the lateral surface propagate in such a way that an overlap of the partial beams is generated in an imaging area, wherein the overlap of the individual partial beams of one wavelength and/or of the partial beams of different wavelengths is circular and/or concentric (with substantially identical centers of an intensity and/or wavelength distribution) and/or comprises a high color mixing once collimation has been effected via the total reflection lens.

The at least two boundary surface portions—wherein a plurality of boundary surface portions pointing in the direction of the second end surface and, preferably spatially, separate from one another are particularly preferably provided—act as transmission portions or, respectively, entry surfaces when light enters the total reflection lens, wherein in general a transition of light from the medium of air to the material of the total reflection lens, preferably glass, is generated.

The imaging area is determined by the geometry of the total reflection lens (such as curvature of the lateral surface) and/or the structural design of the total reflection lens (such as number of boundary surface portions and angle of the boundary surface portions with respect to the optical axis and/or the lateral surface) and can be defined by an area, running along the optical axis of the total reflection lens, in which an overlap area is designed substantially circular.

Before and after the imaging area, the imaging area can be defined as a working area of the total reflection lens, a color mixing can for example be unsuitable for generating particularly favorable overlaps and/or accurate images over different wavelengths, or the overlap is elliptical due to a propagation of partial beams by dispersion, as a result of which evaluation electronics likewise cannot create sufficiently accurate images or diagnoses of the object to be imaged, in particular as objects have a laterally inhomogeneous reflection behavior, and “illumination spots” generated by light sources, preferably over a time lag, should be superimposed to a sufficient extent (as in the case of the imaging area or working area, respectively). A partial overlap can also be a hindrance to obtaining precise images of the object to be analyzed. In the imaging area, which is adapted to the respective area of application via the total reflection lens, however, this issue is eliminated, wherein an inadequate overlap can be utilized to be able to disregard objects outside the imaging area, which are not part of the object to be examined. The imaging area generally extends orthogonally to the optical axis of the total reflection lens.

As stated at the beginning, protection is also sought for an illumination optical system comprising at least two light sources, in particular light-emitting diodes, and at least one such total reflection lens for focusing light from the at least two light sources onto an imaging area common to the two light sources.

As the total reflection lens can be utilized in particular for light sources which are located at a distance from the optical axis of the total reflection lens in the sense of a lateral offset from the optical axis, a plurality of light sources can be utilized, for example in order to increase the intensity of the light or the number of wavelengths for examining the object.

As stated at the beginning, protection is also sought for an array consisting of at least one such illumination optical system and at least one sensor, in particular photodiode, for the electromagnetic detection of light from the at least one illumination optical system reflected at an object.

The use of such a total reflection lens, of such an illumination optical system and/or of such an array for plant recognition and/or ground recognition is particularly preferred.

For example, such an array can be arranged on a piece of agricultural equipment and can recognize individual plants and/or areas of ground specifically to be irrigated. Because weeds are distinguished from other plants by the illumination optical system and via the total reflection lens, the quantity of herbicides and/or pesticides can also be reduced. If the array, for example, recognizes plants to be harvested according to desired criteria, an agricultural surface area can be harvested more effectively. If ground and plants are differentiated, planting is also possible in a more efficient manner.

The use of such a total reflection lens, of such an illumination optical system and/or of such an array for animal recognition, in particular in agriculture, is particularly preferred.

For example, an array arranged on a piece of agricultural equipment such as a mower can recognize animals at a defined distance from the mower and can stop a feed of the mower and/or the mower itself, in order to prevent the risk of injuries to the animals.

The areas of application of the total reflection lens are, however, widespread, wherein the geometry of the total reflection lens (or of the array) can be adjusted to the object to be captured and/or a distance of the object to be captured. The wavelength ranges and/or number of light sources can also be individually adapted to the area of application.

The total reflection lens is particularly preferably used to that effect to uniformly illuminate a remote object with an RGB LED, wherein the hue and/or whiteness is adjustable via a ratio of red, green and/or blue components. The type of LED as light source is, however, generally as desired.

It is entirely conceivable that the total reflection lens, the illumination optical system or the array is used simultaneously for different areas of application—for example for animal recognition, plant recognition and ground recognition.

According to an advantageous design of the invention, the at least one recess is arranged centrally, preferably along an axis of symmetry or an optical axis of the total reflection lens, on the first end surface and/or ends between the two end surfaces. wherein Preferably, a longitudinal extent of the at least one recess is less than one third, particularly preferably one fifth, of a longitudinal extent of the total reflection lens.

However, it is also conceivable that the at least one recess extends substantially over an entire longitudinal extent of the total reflection lens.

The longitudinal extent of the at least one recess is particularly preferably at least one tenth of the longitudinal extent of the total reflection lens, in order to separate a high level of light from a light source via the at least one recess and to be able to collimate split via the lateral surface.

In general, the axis of symmetry of the total reflection lens is congruent with the optical axis of the total reflection lens. In general, the at least one recess can also extend right up to the second end surface. In this context, the axis of symmetry is generally based on an outer contour of the total reflection lens. The at least one recess can likewise have an axis of symmetry, and, in the case of an irregular polygon in cross section, the center of the cross section (of the rotational symmetry) is to be considered.

It is advantageously provided that, in a cross section of the total reflection lens substantially parallel to the first end surface, the at least two boundary surface portions comprise a straight line and/or the at least one recess comprises a traverse.

Through the straight line of the respective boundary surface portion in the cross section of the total reflection lens, it can be guaranteed that light is split into a partial beam and is directed in the direction of the lateral surface for collimation. The number of boundary surface portions corresponds to the number of partial beams of the light which is utilized by the total reflection lens for capturing objects in the imaging area.

A curvature of the boundary surface portions orthogonal to the optical axis is, however, likewise possible, wherein a convex asphere is conceivable in this connection.

The at least one recess, in cross section orthogonal to the optical axis, preferably has a closed polygonal chain, wherein the at least one recess in cross section particularly preferably has no portion with a non-zero curvature (cf. conical design in the state of the art). A curvature of the boundary surface portions orthogonal to the cross section is generally conceivable, wherein in manufacturing terms a constant increase (widening) in the direction of the first end surface and/or a tapering in the direction of the second end surface with increasing curvature of the at least one recess has proved to be favorable.

It has proven to be favorable that the total reflection lens consists of transparent material, preferably glass or plastic, and preferably the total reflection lens is formed as an injection-molded part.

If the total reflection lens is manufactured as an injection-molded part—where appropriate with post-processing steps such as coating, varnishing, grinding processes et cetera—production costs can be reduced in mass production. Examples of plastic materials of the total reflection lens are PMMA, PC or the like.

According to an advantageous embodiment of the invention, the lateral surface comprises a coating, preferably CPC coating, for the substantially complete reflection of light into an area within the lateral surface, preferably substantially in the direction of the second end surface and/or substantially orthogonally to the second end surface.

Through the coating, a level of light which passes through the second end surface can be increased via a minimization of absorption at the lateral surface or egress via the lateral surface.

The technical term CPC coating (compound parabolic concentrator coating) in this context relates to a layer, applied to the lens, which can functionally cause or facilitate the total internal reflection of the total reflection lens, but is generally not imperative.

It has proven to be advantageous that the total reflection lens, preferably the first end surface, the second end surface and/or the at least two boundary surface portions of the at least one recess, has a refractive index in the range of from 1.4 to 1.8, preferably in the range of from 1.45 to 1.6.

It has proven to be particularly advantageous that a chromatic dispersion of the total reflection lens is low. For example, PMMA with a material-characteristic specification of dn/dλ=−0.043329 μm⁻¹ can be used. A chromatic dispersion of the total reflection lens preferably lies in the range between dn/dλ=−0.02 μm⁻¹ and dn/dλ=−0.06 μm⁻¹.

The refractive index or index of refraction can generally influence a geometry of the total reflection lens. Through a suitable geometry of the at least one recess or of the alignment of the at least two boundary surface portions, allowance can be made for the present refractive index.

The refractive index here refers to a wavelength of 587.6 nm and at room temperature.

An advantageous variant is that the at least one recess tapers, starting from the first end surface, in the direction of the second end surface. Preferably, the at least one recess is formed as a truncated pyramid, particularly preferably with convexly curved and/or flat boundary surface portions.

Through the taper and/or the truncated pyramid-like design of the at least one recess, a production process using an injection-molding machine can, for example, be simplified, as a removal of the total reflection lens is made easier. The number of faces of the truncated pyramid is generally as desired and is in particular not limited to four.

It is particularly preferred that the at least one recess comprises at least five or six boundary surface portions, preferably precisely twelve boundary surface portions. Preferably, the at least six boundary surface portions are arranged equidistant and/or along an imaginary circle on the at least one recess.

If at least six boundary surface portions are present, light is split by the total reflection lens into at least six partial beams, which can be utilized for an analysis of an object. In the case of a plurality of light sources, a plurality of at least six partial beams—optionally with different wavelengths—can also be utilized in a data evaluation. For example, however, four boundary surface portions are also conceivable, which extend from a truncated pyramid base (generally in the plane of the first end surface) to a truncated pyramid top surface (as end surface of the at least one recess adjoining the medium of the total reflection lens).

Preferably, the at least two, preferably all, boundary surface portions are formed of equal length parallel and/or orthogonal to the optical axis.

This causes a particularly symmetrical splitting of the bundle of rays into partial beams.

It is particularly preferable that the at least two boundary surface portions are not arranged alternating, oscillating, undulating or in a star shape relative to one another so that, starting from a first boundary surface portion, the next but one boundary surface portion—in particular due to its discontinuous curvature (or continuous curvature due to a radius determined by the manufacturing process)—continues in the same direction, preferably tangentially, as the next (adjoining) boundary surface portion—in particular the discontinuous curvature (or continuous curvature due to a radius determined by the manufacturing process)—relative to the first boundary surface portion.

It is particularly preferable that the at least two boundary surface portions are arranged, preferably exclusively, tangentially relative to one another and/or relative to the at least one recess and/or a contour of the at least one recess.

Tangentially relative to a contour of the at least one recess can be defined by a tangential arrangement along the imaginary circle on the at least one recess.

In general, the at least two boundary surface portions are connected to one another by a radius determined by manufacturing. In the case of a smaller radius, an efficiency of the total reflection lens is increased as less light is scattered in an undesired way within the radius and more light can be utilized for the spectral analysis at the facets of the total reflection lens. The radius is preferably at most 0.5 mm, preferably at most 0.35 mm, particularly preferably at most 0.1 mm. For example, the radius can be at most 10%, preferably at most 5%, particularly preferably at most 2%, of a longitudinal extent of a boundary surface portion orthogonal to the optical axis.

The total reflection lens is particularly preferably suitable and/or provided for splitting light into partial beams along the optical axis through the at least two boundary surface portions separate from one another, in particular formed planar as facets of the at least one recess, in the direction of the lateral surface.

In an embodiment of the invention, the first end surface is formed flat and/or the second end surface comprises a Fresnel lens and/or is formed aspherical or spherical for collimating light from the lateral surface substantially orthogonally to the first end surface. Preferably, in extension of the at least one recess, an aspherical lens, particularly preferably connected in a material-bonding manner to the second end surface, particularly preferably with a smaller lens diameter than the second diameter, is arranged on the second end surface.

Through an aspherical design of the second end surface, light is particularly favorably bundled in the direction of the imaging area when it exits via the second end surface. In the imaging area, a defocused area of the light forms, which can generate a sharp image of the object. In general, the second end surface can, however, also be designed planar, and the collimation is brought about via a curvature of the lateral surface. A spherical design of the second end surface (with optionally present aspherical lens) is also conceivable. During a focusing, because of a lateral offset of light sources relative to the optical axis, a measuring spot would be designed eccentric (in relation to the optical axis), wherein, through a defocusing, the measuring spot can be deformed into a circular ring in order to move the measuring spot along the optical axis in the direction of a center of the imaging area. The greater a focal length of an asphere is, the smaller an eccentricity turns out, as a result of which an asphere with a high focal length is particularly preferred.

Using the aspherical lens as an extension of the total reflection lens, in particular along the optical axis, an additional partial beam of light can be utilized. Preferably, light substantially parallel to the optical axis is directed, via the aspherical lens, substantially parallel to the optical axis in the direction of the imaging area, in order to overlap with the further partial beams of the light in the imaging area.

According to a preferred embodiment of the invention, the at least two light sources are arranged in the area of the first end surface outside the at least one total reflection lens, with the result that light from the at least two light sources can be transmitted via the at least one recess through the second end surface. The at least two light sources are arranged in a plane parallel to the first end surface with a lateral offset around an axis of symmetry, preferably of an optical axis, of the total reflection lens.

In general, the at least two light sources can also be arranged inside the total reflection lens, i.e., in the area of the at least one recess.

Through the boundary surface portions of the at least one recess, light from the at least two light sources is also bundled and focused together in one imaging area in the case of a lateral offset relative to the optical axis. This is also possible in the case of different wavelengths of one light source and/or in the case of different wavelengths of two light sources. For example, one light source can emit light in the green spectrum and a second light source can emit light in the blue and/or red spectrum. Wavelengths in the range between 300 nm and 2200 nm, particularly preferably between 300 nm and 1100 nm, have proved to be advantageous.

It has proven to be favorable that the at least two light sources are formed monochromatic and/or polychromatic. Preferably, the at least two light sources comprise a control device with which the at least two light sources can be operated alternating, particularly preferably pulsed between 1 μs and 20 μs, with light from at least two disjoint wavelength ranges. However, pulse durations up to 100 μs can likewise be used. For example, different operating modes can be implemented by the control device, such as modulated, continuous, simultaneous, chronological et cetera.

Monochromatic is to be interpreted such that a spectrum distribution around a desired spectral line (technically) determined by the light source is also included, wherein a typical FWHM of LEDs between 20 nm and 200 nm can be assumed. Polychromatic is to be interpreted such that the light source can emit monochromatic light of varying wavelengths in an alternating manner, wherein a simultaneous emission of several monochromatic wavelengths is also conceivable.

A pulsed light source in the range between 1 μs and 20 μs guarantees that, in an application on a device with a feed, the feed rate is generally negligible compared with the imaging duration of the object. The pulse duration can be provided for a light source with regard to a change in the wavelengths and/or with respect to several electronically, in particular alternately, switched light sources.

Furthermore, preferably the at least two light sources comprise a primary lens for collimation, which is formed separate from the at least one total reflection lens.

Through the primary lens, light from a light source can particularly advantageously be collimated before it enters the total reflection lens, wherein light from the light source exits the primary lens particularly preferably at a half beam angle of approximately 60°.

In a further embodiment, precisely three light sources are arranged in a triangular grid around an axis of symmetry, preferably of an optical axis, of the total reflection lens.

The object can thereby be imaged with partial beams of light in three wavelengths that are different from one another. A lateral offset of the three light sources is preferably identical relative to the optical axis of the total reflection lens.

An optical axis of the at least one sensor is particularly preferably oriented substantially parallel to the optical axis of the total reflection lens.

According to an advantageous design of the invention, the at least one total reflection lens, preferably the at least one recess, and/or the at least two light sources are formed and/or matched to each other so as to focus light from the at least two light sources via the at least one total reflection lens at a predefinable and/or predefined distance from the at least one total reflection lens with a substantially:
concentric wavelength distribution, and/or
rotationally symmetrical wavelength distribution, and/or
concentric intensity distribution, and/or
rotationally symmetrical intensity distribution.

In the case of a concentric and/or rotationally symmetrical wavelength and/or intensity distribution, an analysis of the spectrum (in particular via the spectra of the individual light sources and/or partial beams) of the same object, which is illuminated by illuminants at different wavelengths for imaging, is particularly simple and possible with high accuracy.

A control and/or regulating unit is particularly preferable, which initiates a procedure depending on an image of the object—a result of images of different wavelengths of the same object—wherein the procedure can for example comprise an imaging-specific actuation of an agricultural spreading device, for example for the selective or spatially differentiated spreading of fluids and/or solids for irrigation, fertilization and/or for plant protection. A quantity of fluids and/or solids can thereby be saved and/or plants can be treated particularly sparingly and/or in consideration of favorable growth properties. Stopping an agricultural machine and/or for example a mower of the machine when suspicious objects are detected is likewise possible.

If the light source is, for example, formed as a light-emitting diode (LED), a specific intensity and/or wavelength distribution, which is optionally collimated via a primary lens of the LED and usually represents a Gaussian distribution, can be emitted via an electronic chip belonging to the light-emitting diode.

After the partial beams of the light from the at least two light sources have exited the second end surface of the total reflection lens, the light generally propagates along the optical axis with an elliptical intensity distribution (due to dispersion) orthogonal to the optical axis. In the imaging area, the intensity distribution substantially adopts a circular intensity distribution orthogonal to the optical axis, which is substantially concentric relative to the at least two light sources. Objects along the optical axis, which are located in this imaging area, can particularly favorably be analyzed with reference to the reflected spectrum, wherein objects outside the imaging area can be removed.

The geometry of the imaging area can be matched to the illumination optical system, for example, via the lateral offset of the at least two light sources, a distance of the at least two light sources along the optical axis of the total reflection lens, an angle of the at least two boundary surface portions relative to the first end surface and/or an orthogonal spacing of the boundary surface portions relative to the optical axis of the total reflection lens.

In the case of a given light source arrangement relative to the total reflection lens, the total reflection lens can be matched by setting the angle of the boundary surface portions relative to the first end surface such that the angles of the partial beams from the light source split via the boundary surface portions (taking the refraction into account) are bundled together at the lateral surface—and generally together with the partial beams from the further light sources—in the imaging area. However, alternatively or in addition, a surface geometry such as curvature of the lateral surface can generally also be adapted to the present requirements. A boundary condition can constitute a distance to the desired imaging area along the optical axis of the total reflection lens or an extent of the imaging area parallel and/or orthogonal to the optical axis of the total reflection lens.

It is, for example, conceivable to adapt, preferably automatically, the distance of the at least two light sources along the optical axis of the total reflection lens during operation of the illumination optical system, in order to alter an imaging area along the optical axis.

According to a preferred embodiment of the invention, at least two sensors, preferably precisely four sensors arranged in pairs, are arranged laterally around the at least one illumination optical system, Preferably, at least one of the at least two sensors and/or the at least two sensors comprise a receiver lens and/or a filter.

A spatial resolution of the image of the object to be examined can particularly favorably be ascertained by at least two sensors using evaluation electronics. The receiver lens collimates and/or focuses the partial beams reflected by the object in the direction of the sensor. The filter can, for example, filter frequency ranges that are not relevant for the imaging, in order to reduce the computing capacity of the evaluation electronics.

It is particularly preferable that evaluation electronics are provided, with which light from the at least one illumination optical system, reflected at an object and detected by the at least one sensor can be differentiated according to wavelengths and/or according to detection position on the at least one sensor.

An image of the object illuminated via the illumination optical system can thereby be created in varying wavelength ranges.

According to an advantageous embodiment of the invention, an image of an object of each wavelength is created by the evaluation electronics, and preferably an object image is created via a plurality of images.

The images can be utilized individually or in combination with one another for the object's diagnosis algorithms, in order for example to identify which object was irradiated with light by the illumination optical system. The objects can be classified, grouped and/or ordered by an algorithm.

At least one scattered light sensor, preferably a photodiode, preferably separated from the at least one sensor by a diaphragm, is preferably provided.

Changes in wavelengths due to aging of the at least two light sources, of an optionally present filter and/or of the at least one sensor can be ascertained by the at least one scattered light sensor. For example, by virtue of the diaphragm, the at least one scattered light sensor measures only the scattered light being generated by the at least two light sources and no light reflected by the object.

Via the evaluation electronics, the at least one scattered light sensor is preferably connected to the illumination optical system, preferably to the at least two light sources, via a light guide.

### BRIEF DESCRIPTION OF THE DRAWINGS

Further details and advantages of the present invention are explained in more detail in the following with reference to the embodiments represented in the drawings with the aid of the description of the figures, in which:

FIGS. 1a-1b show a total reflection lens not according to the invention and a total reflection lens according to the invention in a schematically represented sectional view during capture of an image of an object,

FIG. 2 shows a piece of agricultural equipment with a plurality of arrays consisting of an illumination optical system with a total reflection lens in a schematic representation,

FIGS. 3a-3c show a total reflection lens according to a particularly preferred embodiment in a top view with a sectional representation as well as two perspective views from different viewing angles,

FIG. 4 shows a total reflection lens according to the embodiment according to FIG. 3a in a perspective view of a sectional representation,

FIG. 5 shows an array consisting of an illumination optical system and a total reflection lens according to the embodiment according to FIG. 3a in a top view,

FIGS. 6a-6b show the array according to the embodiment according to FIG. 5 in a perspective view of a sectional representation and a perspective representation with evaluation electronics,

FIGS. 7a-7b are schematic representations of a total reflection lens not according to the invention with different arrangements of a light source,

FIGS. 8a-8b show an imaging area of a total reflection lens with different intensity and wavelength distributions of total reflection lenses not according to the invention relative to total reflection lenses according to the invention.

### DETAILED DESCRIPTION OF THE INVENTION

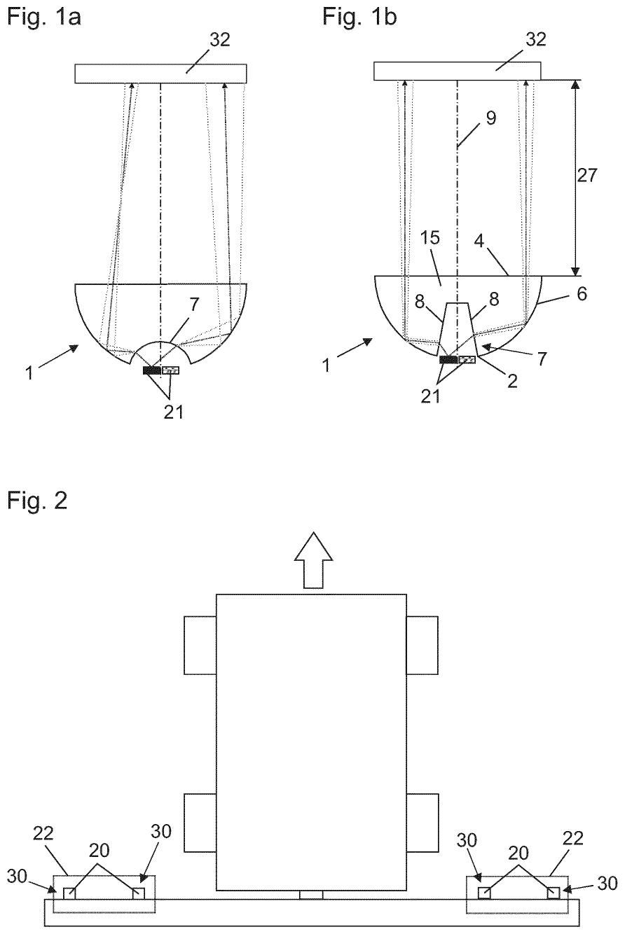

FIG. 1a shows a total reflection lens 1 not according to the invention during an imaging of an object 32, wherein the total reflection lens 1 has a convexly curved recess 7 without boundary surface portions 8 for improved collimation and spectral separation.

FIG. 1b, by contrast, shows a total reflection lens 1 according to the invention, which has a plurality of boundary surface portions 8 (two of these boundary surface portions 8 are visible in the sectional view) in order to separate the light from light sources 21 with a lateral offset 36 (see FIG. 5) relative to the optical axis 9 into partial beams in order to examine the object 32 particularly favorably over different wavelengths with a high collimation effect or overlapping of the partial beams/wavelengths.

FIG. 2 shows an area of application of the total reflection lens 1 in the use of the total reflection lens 1 in an illumination optical system 20 of an array 30 for plant recognition and ground recognition, wherein a plurality of total reflection lenses 1 is arranged on a spraying device of a piece of agricultural equipment. The use of the total reflection lens 1 for animal recognition during agricultural activities is possible at the same time.

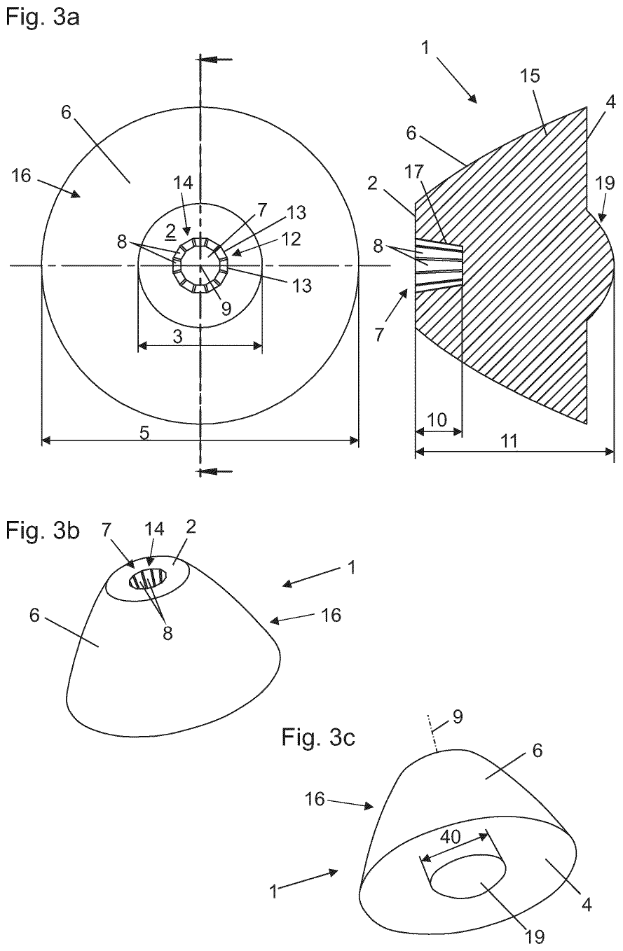

FIG. 3a shows the total reflection lens 1, represented enlarged, wherein the total reflection lens 1 comprises a first end surface 2 with a first diameter 3 and a second end surface 4, arranged parallel to the first end surface 2, with a second diameter 5, wherein the second diameter 5 is greater than the first diameter 3. The two end surfaces 2, 4 are connected to one another via a convexly curved lateral surface 6.

A recess 7 adjoining the first end surface 2 and pointing in the direction of the second end surface 4 is arranged between the first end surface 2 and the second end surface 4, wherein the recess 7 has a plurality of boundary surface portions 8 pointing in the direction of the second end surface 4 and separate from one another for forming partial beams and refracting light in the direction of the lateral surface 6.

The recess 7 is arranged centrally, along an axis of symmetry of the total reflection lens 1 which is congruent with an optical axis 9 of the total reflection lens 1, on the first end surface 2 and ends between the two end surfaces 2, 4, wherein the recess 7 can generally be formed continuous through the total reflection lens 1. A longitudinal extent 10 of the recess 7 is less than one third of a longitudinal extent 11 of the total reflection lens 1, wherein other structural designs are also possible.

In a cross section 12 (indicated by the connection of the boundary surface portions 8 to the first end surface 2 in the representation) of the total reflection lens 1 parallel to the first end surface 2, the boundary surface portions 8 in each case comprise a straight line 13 and the recess 7 comprises a traverse 14.

The recess 7 tapers, starting from the first end surface 2, in the direction of the second end surface 4, wherein the boundary surface portions 8 are formed as planar surfaces. The recess 7 is formed as a truncated pyramid 17, wherein the flat boundary surface portions 8 can generally also be formed convexly curved, in order to facilitate removal from an injection mold.

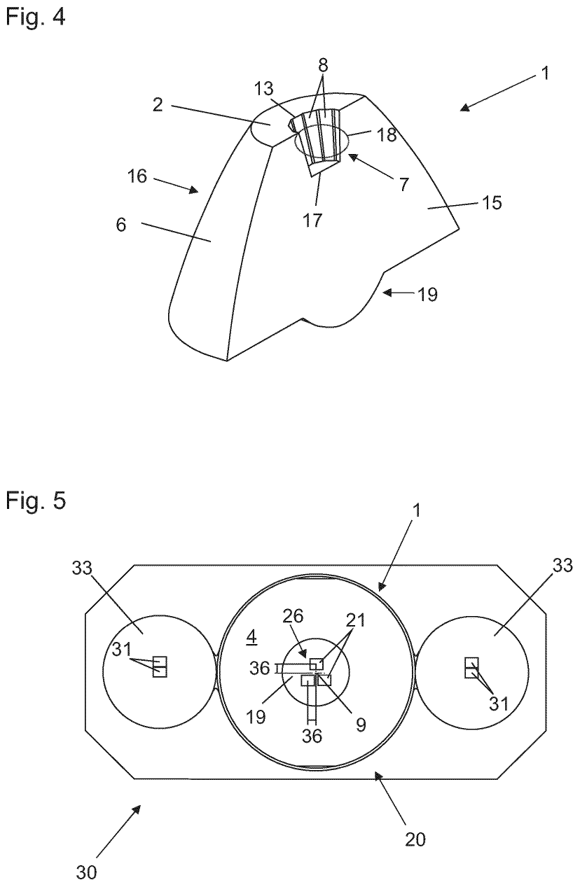

The recess 7 comprises twelve boundary surface portions 8, wherein the boundary surface portions 8 are arranged equidistant and along an imaginary circle 18 on the recess 7 (oriented orthogonally to the optical axis 9—cf. FIG. 4).

FIG. 3b shows the total reflection lens in perspective view, wherein the lateral surface 6 comprises a coating 16 in the form of a CPC coating for the complete reflection of light into an area within the lateral surface 6 in the direction of the second end surface 4 and orthogonally to the second end surface 4. The first end surface 2 is formed flat; but can generally also be formed inclined or curved.

FIG. 3c differs from FIG. 3b merely to the effect that the total reflection lens 1 is observed from a different viewing angle, as a result of which, in extension of the recess 7, an aspherical lens 19, connected in a material-bonding manner to the second end surface 4, with a smaller lens diameter 40 than the second diameter 5 is visible. Alternatively or in addition, the second end surface could be fitted with a Fresnel lens. The second end surface 4 is formed flat, wherein an aspherical or spherical design for collimating light from the lateral surface 6 orthogonally to the first end surface 2 is also conceivable.

FIG. 4 shows the total reflection lens 1 in a section along the optical axis 9, wherein the total reflection lens 1 is formed of transparent material in the form of glass 15. The total reflection lens 1 can, however, also consist of plastic such as PMMA or PC with low chromatic dispersion or be formed by a combination of materials. The total reflection lens 1 is manufactured as an injection-molded part.

The total reflection lens 1 and in particular the first end surface 2, the second end surface 4 and the boundary surface portions 8 of the recess 7 have a refractive index of 1.5.

FIG. 5 shows an array 30 consisting of an illumination optical system 20 and four sensors 31 formed as photodiodes for the electromagnetic detection of light from the illumination optical system 20 reflected at an object 32. The four sensors 31 are arranged in pairs laterally around the illumination optical system 20.

The illumination optical system 20 comprises three light sources 21 in the form of light-emitting diodes (controlled via a chip) and a total reflection lens 1 for focusing light from the light sources 21 onto an imaging area 22 common to the two light sources 21. In this embodiment, exactly three light sources 21 are arranged in a triangular grid 26 around the axis of symmetry and optical axis 9 of the total reflection lens 1.

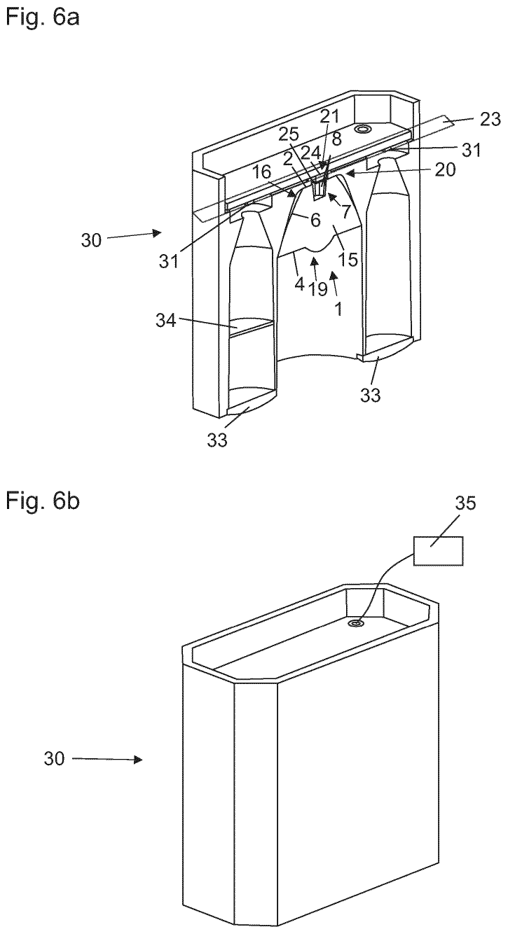

FIG. 6a shows a section through the array 30, wherein the four sensors 31 comprise a receiver lens 33 for in each case two sensors 31, which are spatially spaced apart from the sensors 31 but belong to the respective sensors 31. A pair of the sensors 31 comprises a filter 34 for modifying the spectrum and/or the wavelength of the light from the light sources 21 before detection by the respective sensor 31.

The three light sources 21 are arranged outside the total reflection lens 1 and comprise a primary lens 25 for collimation before entry into the recess 7, wherein the light sources 21 can also be arranged inside the recess 7 (and thus inside the total reflection lens 1) or can in each case comprise a separate primary lens 25 before transmission through the boundary surface portions 8. The primary lens 25 is formed separate from the total reflection lens 1. The light sources 21 are arranged in the area of the first end surface 2 outside the total reflection lens 1, with the result that light from the light sources 21 can be transmitted via the recess 7 through the second end surface 4.

The light sources 21 have a common individually configurable chip for actuation, which can, however, generally be formed separate for each light source 21 for individual actuation. The light sources 21 are arranged in a plane 23 parallel to the first end surface 2 with a lateral offset 24 around the axis of symmetry/the optical axis 9 of the total reflection lens 1.

In this embodiment, two light sources 21 are formed monochromatic and one light source 21 is formed polychromatic, wherein the two light sources 21 comprise a control device 24 with which the two light sources 21 can be operated pulsed alternating between 1 μs and 100 μs. The polychromatic light source 21 can be operated via the control device 24 with light from two disjoint wavelength ranges. The control device 24 is provided for all three light sources 21 together, wherein separate control devices 24 can also be utilized for the individual light sources 21.

A scattered light sensor in the form of a photodiode, which is not visible in the representation and is separated from the sensors 31 by a diaphragm, is provided for the identification of aging phenomena of the light sources 21, wherein the scattered light sensor is connected to the light sources 21 via a light guide.

FIG. 6b shows the array 30 consisting of illumination optical system 20 and total reflection lens 1 with light sources 21 and sensors 31 enclosed in a housing, wherein evaluation electronics 35, in signaling connection with the sensors 31, are provided, with which light from the illumination optical system 20 reflected at an object 32 and detected by the sensors 31 can be differentiated according to wavelengths and according to detection position on the sensors 31. The data transfer to the evaluation electronics 35 can generally also be effected via radio signal, however.

An image of the object 32 of each wavelength can be created by the evaluation electronics 35, wherein an object image can be created via a plurality of images.

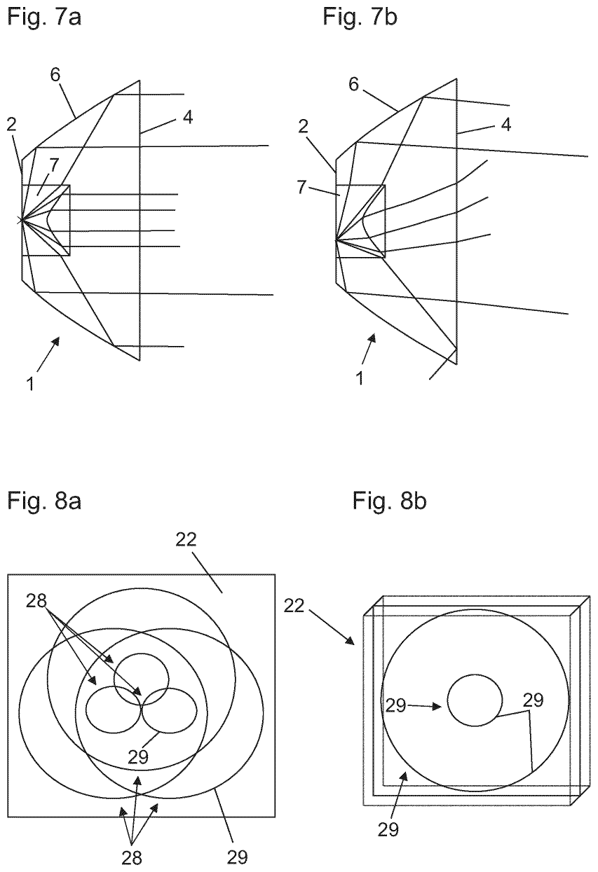

FIG. 7a and FIG. 7b illustrate the problem with regard to conventional total reflection lenses 1, once a light source 21 is arranged with a lateral offset 36 relative to the optical axis 9 and is thus spaced apart from the axis of symmetry orthogonally. In FIG. 7a, the light source 21 is located along the optical axis 9, as a result of which the beam paths of partial beams, collimated as desired, can be focused onto a measuring spot in the imaging area 22. By contrast, in the case of spectral analyses of the object 32 in which different wavelengths are simultaneously utilized for imaging purposes and a lateral offset 36 is necessary, this can no longer be guaranteed in the case of conventional geometries of the total reflection lens 1, as a result of which no proper assessment of the object 32 and no adequate differentiation of sharply desired images of several disjoint wavelengths is effected.

The consequence of total reflection lenses 1 not according to the invention is represented in FIG. 8a, wherein a precise representation of the object 32 over individual wavelengths of the respective light sources 21 is unsatisfactory as the wavelength distribution 28 is not sufficiently overlapping. In addition, the intensity distribution 29 is not concentric and also not rotationally symmetrical, as the beam paths (even for a specific wavelength) cover different distances, are subject to varying dispersion and no boundary surface portions 8 are provided to compensate for this undesired propagation, with the result that combining partial beams results in elliptical and eccentric shapes within the extent of the imaging area 22 (at the desired measuring spot). An accurate analysis of the object 32 is therefore not possible.

In FIG. 8b, by contrast, the total reflection lens 1, the recess 7 and the light sources 21 are formed and matched to each other so as to collimate light from the light sources 21 via the total reflection lens 1 at a predefinable or predefined distance 27 from the total reflection lens 1 with a concentric wavelength distribution 28, a rotationally symmetrical wavelength distribution 28, a concentric intensity distribution 29 and a rotationally symmetrical intensity distribution 29, as a result of which particularly favorable images of the object 32 can be generated and a further processing of the digital information can be effected efficiently and effectively.

1. A total reflection lens comprising:
a first end surface having a first diameter; and
a second end surface parallel to the first end surface and having a second diameter,
wherein the second diameter is greater than the first diameter, and the two end surfaces are connected via a convexly curved lateral surface,
wherein a recess adjoining the first end surface and pointing in a direction of the second end surface is arranged between the first end surface and the second end surface,
wherein the recess has at least two boundary surface portions pointing in the direction of the second end surface and separate from one another for refracting light in a direction of the lateral surface.

2. The total reflection lens according to claim 1, wherein the recess is arranged centrally on the first end surface and/or ends between the two end surfaces, wherein a longitudinal extent of the recess is less than one third of a longitudinal extent of the total reflection lens.

3. The total reflection lens according to claim 1, wherein, in a cross section of the total reflection lens substantially parallel to the first end surface, the at least two boundary surface portions comprise a straight line and/or the recess comprises a traverse.

4. The total reflection lens according to claim 1, wherein the total reflection lens consists of transparent material, and the total reflection lens is formed as an injection-molded part.

5. The total reflection lens according to claim 1, wherein the lateral surface comprises a coating for the substantially complete reflection of light into an area within the lateral surface, substantially in the direction of the second end surface and/or substantially orthogonally to the second end surface.

6. The total reflection lens according to claim 1, wherein the total reflection lens has a refractive index in the range of from 1.4 and 1.8.

7. The total reflection lens according to claim 1, wherein the recess tapers, starting from the first end surface, in the direction of the second end surface, and the recess is formed as a truncated pyramid with convexly curved and/or flat boundary surface portions.

8. The total reflection lens according to claim 1, wherein the recess comprises at least five boundary surface portions, and the at least five boundary surface portions are arranged equidistant and/or along an imaginary circle on the recess.

9. The total reflection lens according to claim 1, wherein the first end surface is formed flat and/or the second end surface comprises a Fresnel lens and/or is formed aspherical or spherical for collimating light from the lateral surface substantially orthogonally to the first end surface.

10. An illumination optical system comprising at least two light sources, and the total reflection lens according to claim 1 for focusing light from the at least two light sources onto an imaging area common to the two light sources.

11. The illumination optical system according to claim 10, wherein the at least two light sources are arranged in the area of the first end surface outside the at least one total reflection lens so that light from the at least two light sources is transmittable via the recess through the second end surface, and the at least two light sources are arranged in a plane parallel to the first end surface with a lateral offset around an axis of symmetry of the total reflection lens.

12. The illumination optical system according to claim 10, wherein the at least two light sources are formed monochromatic and/or polychromatic, the at least two light sources comprise a control device with which the at least two light sources can be operated alternating with light from at least two disjoint wavelength ranges.

13. The illumination optical system according to claim 10, wherein the at least two light sources comprise a primary lens for collimation formed separate from the at least one total reflection lens.

14. The illumination optical system according to claim 10, wherein precisely three light sources are arranged in a triangular grid around an axis of symmetry of the total reflection lens.

15. The illumination optical system according to claim 10, wherein the at least one total reflection lens and/or the at least two light sources are formed and/or matched to each other so as to focus light from the at least two light sources via the at least one total reflection lens at a predefinable and/or predefined distance from the at least one total reflection lens with a substantially:
concentric wavelength distribution, and/or
rotationally symmetrical wavelength distribution, and/or
concentric intensity distribution, and/or
rotationally symmetrical intensity distribution.

16. An array consisting of the illumination optical system according to claim 10 and at least one sensor for the electromagnetic detection of light from the at least one illumination optical system reflected at an object.

17. The array according to claim 16, wherein at least two sensors are arranged laterally around the at least one illumination optical system, and at least one of the at least two sensors and/or the at least two sensors comprise a receiver lens and/or a filter.

18. The array according to claim 16, further comprising evaluation electronics with which light from the at least one illumination optical system, reflected at an object and detected by the at least one sensor, can be differentiated according to wavelengths and/or according to detection position on the at least one sensor.

19. The array according to claim 18, wherein the evaluation electronics are configured to create an image of an object of each wavelength, and an object image is created via a plurality of images including the image.

20. The array according to claim 16, wherein at least one scattered light sensor is provided.
